(19) United States
(12) Patent Application Publication
(10) Pub. No.: US 2008/0093183 A1
(43) Pub. Date: Apr. 24, 2008

(54) Actuator System

(76) Inventors: Alfons Maier, Bad Abbach (DE); Jurgen Sturzer, Aiterhofen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/908,749

(22) PCT Filed: Feb. 17, 2006
(86) PCT No.: PCT/EP06/60052

§ 371 Date: Sep. 14, 2007

(30) Foreign Application Priority Data
Mar. 23, 2005 (EP) 05006397.3

(51) Int. Cl. B60T 13/74; B60T 11/06; B60T 7/10

(52) U.S. Cl. 188/156

(57) ABSTRACT

An actuator system (5) has an electric actuating drive (7) and a first and a second output shaft. The actuator system (5) additionally has at least one actuating element which is coupled to the first output shaft and/or to the second output shaft. The actuating element is designed for coupling to a transmission element. In conjunction with the transmission element, the actuating element converts a rotary motion of the first output shaft or of the second output shaft into a linear motion of the transmission element. In addition, the actuator system (5) has a differential which is coupled on the input side to the electric actuating drive (7) and which has the first output shaft and the second output shaft. The differential is designed to transmit and distribute an input-side torque to the first output shaft and the second output shaft.

### CROSS-REFERENCE TO RELATED APPLICATIONS

This application is a U.S. national stage application of International Application No. PCT/EP2006/060052 filed Feb. 17, 2006, which designates the United States of America, and claims priority to European application number 05006397.3 filed Mar. 23, 2005, the contents of which are hereby incorporated by reference in their entirety.

### TECHNICAL FIELD

The invention relates to an actuator system, particularly an actuator system for an electrically adjustable brake, for example a handbrake of a motor vehicle, which comprises an electric actuating drive and a first and a second output shaft.

### BACKGROUND

Electrically adjustable brakes, for example in motor vehicles, should be operated with a braking force which is as far as possible equally great on both sides of the motor vehicle, in order for example to be able to reliably prevent the motor vehicle from rolling away. For reasons of cost and for reasons of the available construction space, the braking force is however preferably applied by only one electric actuating drive. A torque which is generated by means of the electric actuating drive should thus be distributed to the opposite sides of the motor vehicle such that the braking force on both sides of the motor vehicle is equal in size.

### SUMMARY

According to an embodiment, a reliable actuator system can be created by an actuator system comprising an electric actuating drive, a first output shaft and a second output shaft, at least one actuating element which is coupled to the first output shaft and/or to the second output shaft and which is designed for coupling to a transmission element and which in conjunction with the transmission element converts a rotary motion of the first output shaft or of the second output shaft into a linear motion of the transmission element, and a differential which is coupled on the input side to the electric actuating drive and which comprises the first output shaft and the second output shaft and which is designed to transmit and distribute a torque on the input side to the first output shaft and the second output shaft, wherein the first output shaft and/or the second output shaft comprises a spindle, respectively.

According to an enhancement, the first output shaft and the second output shaft can be arranged on a common axis of rotation and facing away from one another on the output side. According to a further enhancement, the actuator system can be designed such that the first output shaft and the second output shaft can be twisted with respect to one another in a first drive direction of the electric actuating drive and have a fixed position with respect to one another in a second drive direction of the electric actuating drive. According to a further enhancement, the first output shaft can be designed as a hollow shaft, and the second output shaft can be arranged so that it can rotate in the hollow shaft. According to a further enhancement, the first output shaft may have a first bevel gear and the second output shaft may have a second bevel gear, and the differential may comprise a differential casing which takes up the torque on the input side and on which at least one planetary bevel gear which can rotate is arranged, by way of which the first bevel gear and the second bevel gear are coupled to one another. According to a further enhancement, two planetary bevel gears can be arranged opposite one another on a common axis of rotation. According to a further enhancement, the differential can be implemented as a spur-gear differential gear. According to a further enhancement, the differential may comprise a differential casing which takes up the input-side torque and on which at least one spur gear planetary gear set is arranged to be capable of rotation, which couples the first output shaft and the second output shaft with one another. According to a further enhancement, the differential may comprise at least three spur gear planetary gear sets which are arranged evenly around the first output shaft and the second output shaft.

### BRIEF DESCRIPTION OF THE DRAWINGS

Embodiments of the invention will be described in the following with reference to the schematic drawings.

In the drawings:

FIG. 1A shows a first arrangement of an actuator system in a motor vehicle,

FIG. 1B shows a second arrangement of the actuator system in the motor vehicle,

FIG. 2 shows a first embodiment of the actuator system,

FIG. 3 shows a part of the first embodiment of the actuator system,

FIG. 4 shows a cross-section through a first differential,

FIGS. 5A, B show a first arrangement of actuating elements,

FIGS. 6A, B show a second arrangement of the actuating elements,

FIG. 7 shows a second embodiment of the actuator system,

FIG. 8 shows a second differential,

FIG. 9 shows a part of the second differential,

FIG. 10 shows a further part of the second differential.

Elements having the same construction or function are identified by the same reference characters in all the figures.

### DETAILED DESCRIPTION

According to an embodiment, an actuator system comprises an electric actuating drive and a first and a second output shaft. The actuator system additionally comprises at least one actuating element which is coupled to the first output shaft and/or to the second output shaft. The actuating element is designed for coupling to a transmission element. In conjunction with the transmission element, the actuating element converts a rotary motion of the first output shaft or of the second output shaft into a linear motion of the transmission element. In addition, the actuator system comprises a differential which is coupled on the input side to the electric actuating drive and which comprises the first output shaft and the second output shaft. The differential is designed in order to transmit and distribute an input-side torque to the first output shaft and the second output shaft.

According to an embodiment, the transmission element can be for example a cable or a rod. Such a cable or rod is coupled for example to a brake and the brake is actuated for example by pulling on the cable or on the rod. The provision of the differential has the advantage that for example different lengths, tolerances for example, and tensile and/or compressive forces of the transmission element can be reliably compensated for the respective side of the vehicle. After equalization of the length has been performed, the brake on the respective side of the vehicle can then be actuated with an equally great braking force. In addition, the actuator system has the advantage that it can be designed to be small and compact and thus requires only a little construction space.

According to an embodiment of the actuator system, the first output shaft is designed as a hollow shaft. The second output shaft is arranged so that it can rotate in the hollow shaft. The advantage is that the actuator system can thus be designed to be particularly small and compact. In addition, the first and the second output shaft and the respective actuating element which may be provided can be arranged on the same side of the differential. This has the advantage that the transmission elements, which are coupled to the first or to the second output shaft, can be routed close together and parallel to one another. As a result, such an actuator system is especially suited to being located for example in a transmission tunnel of a motor vehicle in the area of a handbrake.

According to a further embodiment of the actuator system, the first output shaft has a first bevel gear. The second output shaft has a second bevel gear. The differential comprises a differential casing which takes up the torque on the input side. At least one planetary bevel gear which can rotate is arranged on the differential casing, by way of which the first bevel gear and the second bevel gear are coupled to one another. The advantage is that such a differential can be designed in an extremely compact form. In addition, such a differential has a simple construction. Such a differential makes it possible to reliably compensate for different lengths or tolerances, of the transmission elements for example, and of the torques on the output side on the first and the second output shafts.

In this context it can be advantageous if two planetary bevel gears are arranged opposite one another on a common axis of rotation. The advantage is that forces occurring in the differential are distributed approximately symmetrically to both planetary bevel gears. As a result, any loading on bearings of the differential is reduced and the life of the differential can thus be extended. In addition, it is possible to avoid any wedging of the bevel gears or of the planetary bevel gears resulting from asymmetric loading. Such a differential is particularly reliable.

According to a further embodiment of the actuator system, the actuating element is a pulley wheel which can be coupled to a cable. This cable, which is the brake cable for example, forms the transmission element for transmission of a braking force to the brake for example. Such a pulley wheel can very simply convert the rotary motion of the first or the second output shaft and of the pulley wheel coupled to it into a linear motion of the cable by coiling up or uncoiling the cable. The pulley wheel can be designed in circular form or also with a different rotary profile. The pulley wheel can additionally be arranged axially or eccentrically on the respective output shaft. Such an actuating element is extremely simple and favorably priced.

In this context, it can be advantageous if the first output shaft and the second output shaft are each coupled to an actuating element which is designed as a pulley wheel. The pulley wheels are arranged parallel to one another such that the cables can be pulled through them in the same direction when the pulley wheels are each coupled to a cable. This can be particularly advantageous if the actuator system is arranged for example in the transmission tunnel of the motor vehicle in the area of the handbrake. The cables can then be arranged for example parallel to a longitudinal vehicle axis. Alternatively, the pulley wheels are arranged parallel to one another such that the cables can be pulled through them in opposite directions when the pulley wheels are each coupled to a cable. This has the advantage that the actuator system can be arranged for example on a vehicle wheel axle. The cables can then be arranged for example at right angles to the longitudinal vehicle axis. The advantage is that in this way particularly short cables can be used and the actuator system can be arranged in a particularly space-saving manner on the vehicle wheel axle. As a result, when a motor vehicle is assembled the actuator system can for example be pre-assembled together with the vehicle wheel axle. The use of short brake cables can result in greater efficiency such that only a small output is required from the electric actuating drive in order to apply the brake. The actuator system can be particularly favorably priced as a result.

According to a further embodiment of the actuator system, the first output shaft and/or the second output shaft comprises a spindle in each case. This has the advantage that a spindle can very simply convert the rotary motion of the first output shaft and/or the second output shaft and in accordance with the associated spindle into a linear motion, for example of the transmission element.

According to a further embodiment of the actuator system, the first output shaft and the second output shaft are arranged on a common axis of rotation and facing away from one another on the output side. This has the advantage that tensile forces which are transmitted by way of the respective transmission element or actuating element to the associated output shaft act along the common axis of rotation. In addition, such an actuator system is particularly suitable for placing on the vehicle wheel axle for example and can be simply pre-assembled with the latter. Such an arrangement is particularly space-saving. In addition, the transmission elements such as the brake cables or the rods can be designed to be particularly short. As a result, a high level of efficiency can be achieved, such that the power output from the electric actuating drive can be low. The actuator system is thus particularly favorably priced.

According to a further embodiment of the actuator system, the differential is designed as a spur-gear differential gear. This has the advantage that for example different lengths or tolerances of the transmission elements and different torques on the first and the second output shafts can be compensated for in a particularly reliable manner. In addition, such an actuator system can be designed to be particularly small and compact.

In this context it can be advantageous if the differential comprises a differential casing which takes up the input-side torque. At least one spur-gear planetary gear set is arranged to be capable of rotation on the differential casing. The at least one spur-gear planetary gear set couples the first output shaft and the second output shaft with one another. Such a differential can be designed to be particularly small and compact.

In this context it can be also advantageous if the differential comprises at least three spur-gear planetary gear sets. The spur-gear planetary gear sets are arranged evenly around the first output shaft and the second output shaft. This has the advantage that loading on the bearings of the differential is even and low. This enables the differential to have a long life.

According to a further embodiment of the actuator system, the actuator system is designed such that the first output shaft and the second output shaft can be twisted with respect to one another in a first drive direction of the electric actuating drive and have a fixed position with respect to one another in a second drive direction of the electric actuating drive. The advantage is that the compensation for different lengths and torques is effective only in one drive direction. This can be advantageous for example in the situation when two cables or rods are to be pulled evenly. In the opposite drive direction it can however be advantageous to release the cables or rods without compensating for the lengths or forces.

FIG. 1a shows a motor vehicle 1 which has on a rear vehicle wheel axle a first brake 2 for a wheel on the right-hand side of the vehicle and a second brake 3 for a wheel on the left-hand side of the vehicle. The first brake 2 is coupled by way of a first brake cable 4 to an actuator system 5 which for example is part of an electrically adjustable brake, in particular an electronic handbrake, of the motor vehicle 1. Correspondingly, the second brake 3 is coupled by way of a second brake cable 6 to the actuator system 5. The actuator system 5 is located for example in a transmission tunnel of the motor vehicle 1, in the area of a handbrake for example.

Alternatively, the actuator system 5 can however also be located in the vicinity of a vehicle wheel axle, for example E the rear vehicle wheel axle of the motor vehicle 1 (FIG. 1b). To this end, the actuator system 5 can be preferably mounted on the vehicle wheel axle of the motor vehicle 1. This has the advantage that such an arrangement comprising vehicle wheel axle and actuator system 5 can be pre-assembled for assembly of the motor vehicle 1. This can simplify the assembly of the motor vehicle 1. The actuator system 5 can however also be mounted on a chassis of the motor vehicle 1. The first brake cable 4 and the second brake cable 6 extend parallel to the vehicle wheel axle of the motor vehicle 1 in opposite directions and thus at right angles to a longitudinal vehicle axis.

The first brake cable 4 and the second brake cable 6 should be able to be moved a predefined distance by the actuator system 5 and/or tensioned with a predefined force in order to allow the first brake 2 and the second brake 3 to be operated reliably.

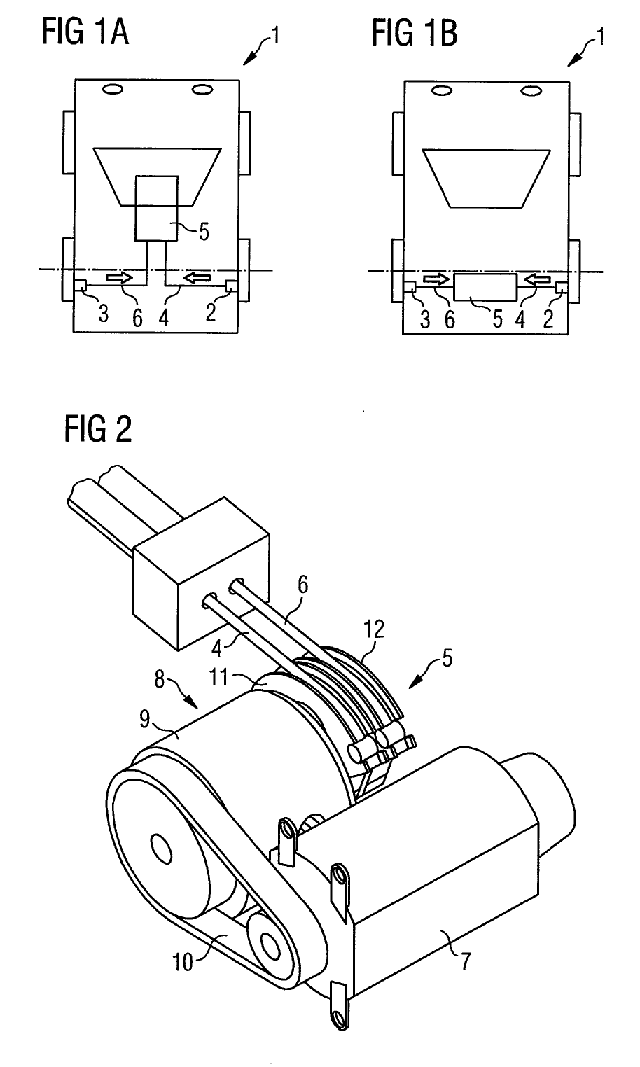

In a first embodiment of the actuator system 5 the actuator system 5 comprises an electric actuating drive 7 and a first differential 8 (FIG. 2). The first differential 8 comprises a differential casing 9 which is coupled to the electric actuating drive 7 by way of a drive belt 10. The differential casing 9 and the electric actuating drive 7 can however also be coupled to one another differently, for example by way of gear wheels or by way of a worm gear. The differential casing 9 constitutes an input for a torque which is provided by the electric actuating drive 7 when power is suitably applied to the latter.

The actuator system 5 also comprises two actuating elements which are implemented as a first pulley wheel 11 and a second pulley wheel 12. The first pulley wheel 11 or the second pulley wheel 12 can be designed in circular form, but it can also have any other suitable contour in the rotary direction. The first pulley wheel 11 and the second pulley wheel 12 are designed such that the first brake cable 4 and the second brake cable 6 can each be coupled to one of the pulley wheels. In addition, the first pulley wheel 11 and the second pulley wheel 12 are designed such that the first brake cable 4 or the second brake cable 6 can be coiled up onto the respective pulley wheel or uncoiled from the latter by twisting the first pulley wheel 11 or the second pulley wheel 12 respectively. As a result, a rotary motion of the first pulley wheel 11 or of the second pulley wheel 12 can very simply be converted into a linear motion of the first brake cable 4 or of the second brake cable 6. The first brake cable 4 and the second brake cable 6 can also be referred to as transmission elements which are designed in order to transmit a force which can be produced by the actuator system 5 to the first brake 2 or the second brake 3.

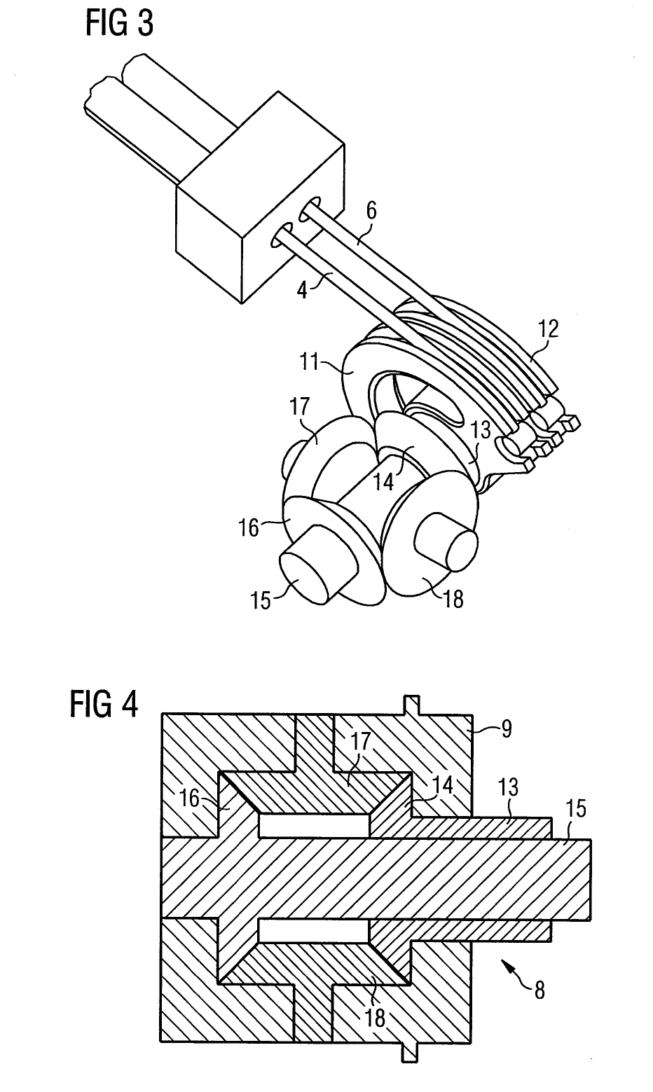

The first differential 8 comprises a first output shaft 13 which is designed as a hollow shaft (FIG. 3 and FIG. 4). The first pulley wheel 11 is coupled to the first output shaft 13. The first output shaft 13 comprises a first bevel gear 14. The first differential 8 additionally comprises a second output shaft 15 which is arranged coaxially with respect to the first output shaft 13 and can rotate therein. The second pulley wheel 12 is coupled to the second output shaft 15. The second output shaft 15 comprises a second bevel gear 16. The first pulley wheel 11 or the second pulley wheel 12 are arranged centered with respect to the first output shaft 13 or the second output shaft 15 respectively, but can also be arranged eccentrically with respect to these.

The first differential 8 additionally comprises a first planetary bevel gear 17 and a second planetary bevel gear 18. The first planetary bevel gear 17 and the second planetary bevel gear 18 are arranged along a common axis of rotation which runs perpendicular to an axis of rotation of the first output shaft 13 and the second output shaft 15. The first planetary bevel gear 17 and the second planetary bevel gear 18 are arranged such that they serve to couple together the first bevel gear 14 of the first output shaft 13 and the second bevel gear 16 of the second output shaft 15. The first planetary bevel gear 17 and the second planetary bevel gear 18 are additionally mounted rotatably in the differential casing 9.

It is also possible to provide only one planetary bevel gear or also more than two planetary bevel gears in the first differential 8. A symmetrical arrangement of the planetary bevel gears can be however particularly advantageous because forces or torques occurring can thus be distributed evenly to the planetary bevel gears. This can reduce loading on the bearings and thus increase the life of the first differential 8.

The first bevel gear 14, the second bevel gear 16, the first planetary bevel gear 17 and the second planetary bevel gear 18 preferably may exhibit a toothing which allows reliable transmission of the respective torques between the first bevel gear 14, the second bevel gear 16, the first planetary bevel gear 17 and the second planetary bevel gear 18.

The first differential is designed such that the particular output shaft at which a lower torque is acting against the drive can be preferably driven by the electric actuating drive 7 by way of the differential casing 9, the first planetary bevel gear 17 and the second planetary bevel gear 18. This is the case for example in the situation when the brake cable is tensioned tightly on one of the pulley wheels but the other brake cable is not tensioned tightly on the other pulley wheel. The compensation is performed such that both brake cables are tensioned approximately equally tightly. It is thus possible to ensure that a braking force of approximately equal magnitude is transmitted by way of the first brake cable 4 and the second brake cable 6 to the first brake 2 and to the second brake 3.

The second output shaft 15 can also be designed such that the second pulley wheel 12 can be arranged at an end of the second output shaft 15 axially facing away from the first output shaft 13. The advantage is that the first output shaft 13 does not need to be designed as a hollow shaft and that if necessary the first output shaft 13 and the second output shaft 15 can be designed in the same way. Consequently, fewer components differing from one another are required, with the result that the first differential 8 can be favorably priced.

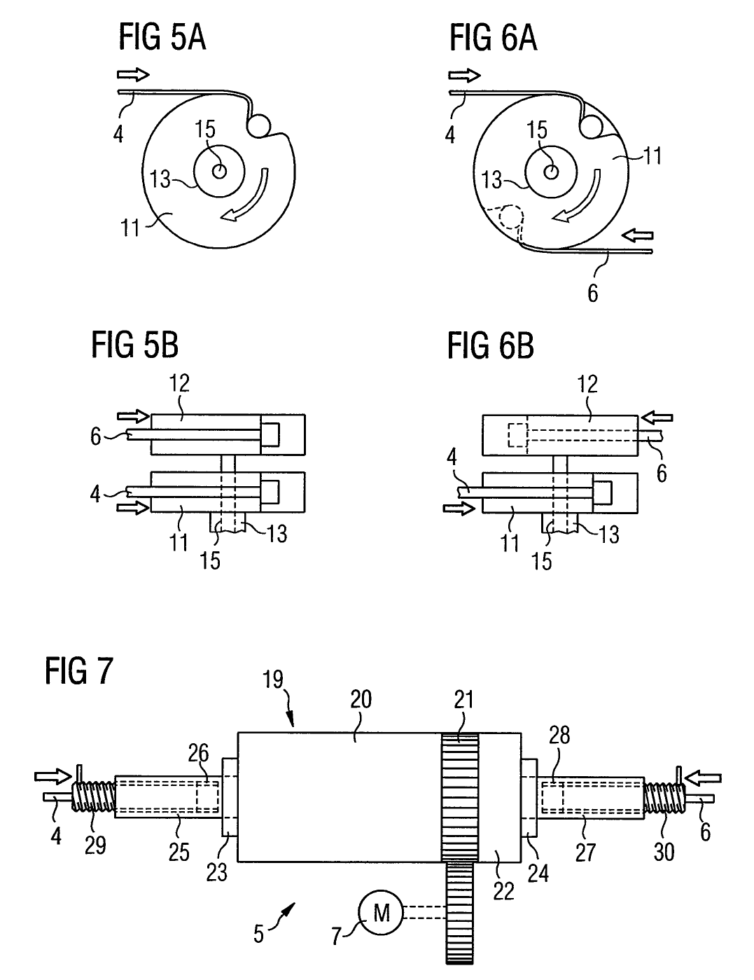

FIG. 5a and FIG. 5b show a first arrangement of the first pulley wheel 11 and the second pulley wheel 12. In this first arrangement, the first brake cable 4 and the second brake cable 6 can be pulled parallel to one another and in the same direction. This first arrangement is particularly suitable for arranging the actuator system 5 for example in the transmission tunnel of the motor vehicle 1 (FIG. 1a).

FIG. 6a and FIG. 6b correspondingly show a second arrangement in which the first pulley wheel 11 and the second pulley wheel 12 are arranged such that the first brake cable 4 and the second brake cable 6 can be pulled in opposite directions. To this end, the second pulley wheel 12 is arranged for example twisted by about 180 degrees with respect to the first pulley wheel 11. This second arrangement is particularly suitable for arranging the actuator system 5 in the area of the vehicle wheel axle (FIG. 1b). In the second arrangement, the actuator system 5 is arranged twisted correspondingly by 90 degrees compared with the first arrangement in the motor vehicle 1.

As an alternative to the first pulley wheel 11 and the second pulley wheel 12, it is also possible to provide other actuating elements which can each be coupled to a transmission element, for example the first brake cable 4, the second brake cable 6 or also to a suitable rod. Spindles for example are particularly suitable.

In a second embodiment of the actuator system 5, the actuator system 5 comprises the electric actuating drive 7 and a second differential 19 which includes a differential casing 20 (FIG. 7). The differential casing 20 is provided with a toothing 21. The electric actuating drive 7 is coupled for example by way of one or more gear wheels to the differential casing 20 of the second differential 19 in the area of the toothing 21. The electric actuating drive 7 can however also be coupled differently to the differential casing 20, for example by way of the drive belt 10. A housing cap 22 is arranged on the differential casing 20. A first bearing 23 is provided on the side of the differential casing 20 opposite the housing cap 22. A second bearing 24 is correspondingly provided in the housing cap 22.

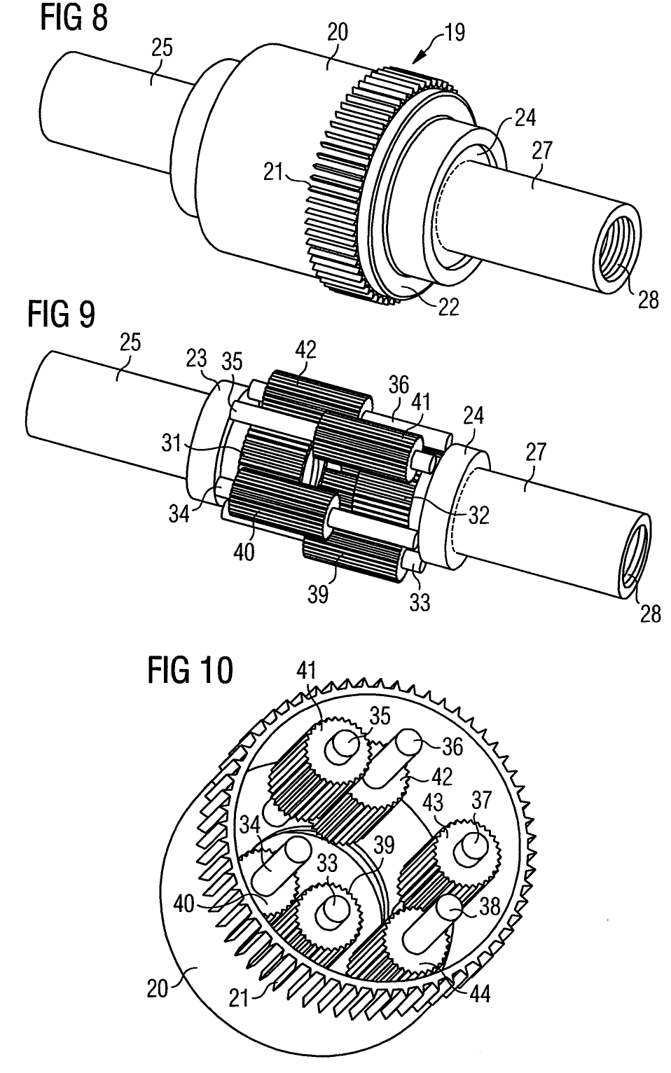

The second differential 19 comprises two output shafts which correspond in their functionality in the actuator system 5 to the first output shaft 13 and the second output shaft 15, but which each comprises a spindle or are designed as a spindle (FIG. 7 and FIG. 8). A first spindle 25 has a first internal thread 26 and is mounted in the first bearing 23. Correspondingly, a second spindle 27 has a second internal thread 28 and is mounted in the second bearing 24. Into the first internal thread 26 of the first spindle 25 is screwed a first spindle screw 29 which is arranged in a fixed rotary position, for example on a casing which may be provided for the actuator system 5, and can be moved axially. The first spindle screw 29 is designed such that it can be coupled to the first brake cable 4. Correspondingly, a second spindle screw 30, which is arranged in a fixed rotary position and can be moved axially, is screwed into the second internal thread 28 of the second spindle 27. The second spindle screw 30 is designed such that it can be coupled to the second brake cable 6.

The first spindle 25 or the second spindle 27 can also be provided with an external thread. Correspondingly, the first spindle screw 29 and the second spindle screw 30 can also be designed as a spindle nut and be screwed on to the respective external thread of the first spindle 25 or the second spindle 27.

The output shafts to which the first spindle 25 and the second spindle 27 respectively are assigned are arranged positioned along a common axis of rotation and preferably in a fixed axial position, in other words not axially movable. The first spindle screw 29 and the second spindle screw 30 are arranged such that they exhibit opposite directions with regard to the respective brake cable. This embodiment is thus particularly suitable for being arranged in the area of the vehicle wheel axle of the motor vehicle 1 (FIG. 1b).

The output shaft to which the first spindle 25 is assigned has toothing 31, which is designed in the longitudinal direction (FIG. 9), in an area of its surface at an axial end facing the second spindle 27. Correspondingly, output shaft to which the second spindle 27 is assigned has toothing 32, which is designed in the longitudinal direction, in an area of its surface at an axial end facing the first spindle 25.

A first shaft 33, a second shaft 34, a third shaft 35, a fourth shaft 36, a fifth shaft 37 and a sixth shaft 38 are arranged and bearing mounted on the differential casing 20 and/or on the housing cap 22 (FIG. 9 and FIG. 10) in the longitudinal direction parallel to the output shafts. A first planetary spur gear 39 is arranged on the first shaft 33. A second planetary spur gear 40 is correspondingly arranged on the second shaft 34. The first planetary spur gear 39 and the second planetary spur gear 40 form a spur-gear planetary gear set. The first planetary spur gear 39 and the second planetary spur gear 40 are coupled to one another. Correspondingly, a third planetary spur gear 41 and a fourth planetary spur gear 42 are provided which are arranged on the third shaft 35 and the fourth shaft 36 and which constitute a second spur-gear planetary gear set, and a fifth planetary spur gear 43 and a sixth planetary spur gear 44 which are arranged on the fifth shaft 37 and the sixth shaft 38 and which constitute a third spur-gear planetary gear set. The first planetary spur gear 39, the third planetary spur gear 41 and the fifth planetary spur gear 43 are each coupled to the second spindle 27 in the area of the toothing 32. Correspondingly, the second planetary spur gear 40, the fourth planetary spur gear 42 and the sixth planetary spur gear 44 are coupled to the first spindle 25 in the area of the toothing 31. To this end, the respective planetary spur gears of a spur-gear planetary gear set are arranged axially displaced with respect to one another on their respective shaft. The second differential 19 is designed as a spur-gear differential gear.

The second differential 19 can also have only one or two or also more than three spur-gear planetary gear sets. It can be however advantageous to provide at least three spur-gear planetary gear sets. By this means, the loading on the first bearing 23 and the second bearing 24 can be less or more even than with only one or two spur-gear planetary gear sets.

The differential casing 20 is driven by the electric actuating drive 7 in one of two possible drive directions when power is suitably applied to the latter. If a torque which for example is transmitted by way of the first brake cable 4 and the first spindle screw 29 to the first spindle 25 and which acts in opposition to the drive direction is less than a torque which is transmitted by way of the second brake cable 6 and the second spindle screw 30 to the second spindle 27 and which acts in opposition to the drive direction, then the first spindle 25 can be preferably driven only until such time as the torque of the first spindle 25 and the torque of the second spindle 27 are approximately equal. Both the first spindle 25 and also the second spindle 27 can then be driven by way of the differential casing 20 and a torque which is transmitted from the electric actuating drive 7 to the differential casing 20 is transmitted approximately equally to the first spindle 25 and the second spindle 27. Correspondingly, the second spindle 27 can be preferably driven only until such time as the torque of the second spindle 27 is less than the torque of the first spindle 25. By this means, it is for example possible to compensate for different lengths of the first brake cable 4 or of the second brake cable 6 or tolerances for example of the first brake 2 or of the second brake 3 and to exert an approximately equal tensile force or braking force on the first brake cable 4 and the second brake cable 6 or the first brake 2 and the second brake 3.

As an alternative or in combination with the first brake cable 4 and the second brake cable 6, it is also possible in each case to use a suitably designed rod as a transmission element. A rod can be designed such that it can also be used for example to transmit thrust forces. In addition, as an alternative to the output shaft with the first spindle 25 and with the first spindle screw 29 and to the output shaft with the second spindle 27 and with the second spindle screw 30, the output shafts can also be coupled to actuating elements other than the first spindle screw 29 and the second spindle screw 30, to pulley wheels for example.

By preference, the first bearing 23 and the second bearing 24 are each designed as a one-way bearing. By this means, it is possible for the first spindle 25 and the second spindle 27 to be capable of twisting with respect to one another in a first drive direction of the electric actuating drive if the resulting torques acting on the first spindle 25 and the second spindle 27 are different, and have fixed positions with respect to one another in a second drive direction of the electric actuating drive 7. The compensation for different lengths of the first brake cable 4 and of the second brake cable 6 or of corresponding rods and for different levels of torque of the first spindle 25 and of the second spindle 27 is thus possible only in the first drive direction of the electric actuating drive. By preference, the first drive direction of the electric actuating drive corresponds to a traction direction in which the first brake 2 and the second brake 3 are pulled so that the motor vehicle 1 can be prevented from rolling away. The second drive direction of the electric actuating drive 7 then corresponds to a release direction which is used for releasing the first brake 2 and the second brake 3 in order to allow the motor vehicle 1 to be driven. With regard to releasing the first brake 2 and the second brake 3, it can be advantageous if both brakes are released equally. This can be advantageous particularly in the situation when one of the two brakes or brake cables is jammed, for example when it freezes up in winter or malfunctions, since the second differential 19 would then release only the other brake in question. Thanks to the use of one-way bearings it is possible to prevent an asymmetric release of the brakes.

By preference, the actuator system 5 is designed such that the torque which acts on the first output shaft 13 or the second output shaft 15, or on the first spindle 25 or the second spindle 27, does not result in any alteration of the actuator system 5, in other words such that a rotary position of the first output shaft 13 and the second output shaft 15 or of the first spindle 25 and the second spindle 27 is maintained as long as power is not applied to the electric actuating drive 7 in order to move the first output shaft 13 and the second output shaft 15 or the first spindle 25 and the second spindle 27. This can be achieved for example by means of a self-locking facility or by means of a locking or braking mechanism which is provided in the actuator system 5, for example in the electric actuating drive 7. By preference, however, a holding brake mechanism is provided which can be preferably arranged such between the electric actuating drive 7 and the first differential 8 or the second differential 19 that the holding brake mechanism is coupled on the input side to the electric actuating drive 7 and is coupled on the output side to the first differential 8 or the second differential 19.

Both the first embodiment and also the second embodiment of the actuator system 5 are suited for operation with only one power take-off, in other words also with only one actuating element. By fixing the first output shaft 13 or the second output shaft 15 or correspondingly the first spindle 25 or the second spindle 27 to the casing which may be provided for the actuator system 5, it is possible to achieve a state whereby the input-side torque which is transmitted by the electric actuating drive 7 to the differential casing 9 of the first differential 8 or to the differential casing 20 of the second differential 19 is available at the one power take-off. This has the advantage that the actuator system 5 can also very simply be used for those types of applications which require only one power take-off, in other words which for example have only one brake cable.

In addition, both the first embodiment and also the second embodiment of the actuator system 5 can be used not only in motor vehicles but also in any situation where a linear tensile force or thrust force of equal magnitude as far as possible is required at two power take-offs and, in addition, tolerances, such as different lengths of the transmission elements for example, may need to be compensated for.

What is claimed is:

1. An actuator system comprising:
an electric actuating drive,
a first output shaft and a second output shaft,
at least one actuating element which is coupled to the first output shaft and/or to the second output shaft and which is designed for coupling to a transmission element and which in conjunction with the transmission element converts a rotary motion of the first output shaft or of the second output shaft into a linear motion of the transmission element, and
a differential which is coupled on the input side to the electric actuating drive and which comprises the first output shaft and the second output shaft and which is designed to transmit and distribute a torque on the input side to the first output shaft and the second output shaft, wherein the first output shaft and/or the second output shaft comprises a spindle, respectively.

2. The actuator system according to claim 1, wherein the first output shaft and the second output shaft are arranged on a common axis of rotation and facing away from one another on the output side.

3. The actuator system according to claim 1, wherein the actuator system is designed such that the first output shaft and the second output shaft can be twisted with respect to one another in a first drive direction of the electric actuating drive and have a fixed position with respect to one another in a second drive direction of the electric actuating drive.

4. The actuator system according to claim 1, wherein the first output shaft is designed as a hollow shaft, and in which the second output shaft is arranged so that it can rotate in the hollow shaft.

5. The actuator system according to claim 1, wherein the first output shaft has a first bevel gear and the second output shaft has a second bevel gear, and wherein the differential comprises a differential casing which takes up the torque on the input side and on which at least one planetary bevel gear which can rotate is arranged, by way of which the first bevel gear and the second bevel gear are coupled to one another.

6. The actuator system according to claim 5, wherein two planetary bevel gears are arranged opposite one another on a common axis of rotation.

7. The actuator system according to claim 1, wherein the differential is implemented as a spur-gear differential gear.

8. The actuator system according to claim 7, wherein the differential comprises a differential casing which takes up the input-side torque and on which at least one spur gear planetary gear set is arranged to be capable of rotation, which couples the first output shaft and the second output shaft with one another.

9. The actuator system according to claim 8, wherein the differential comprises at least three spur gear planetary gear sets which are arranged evenly around the first output shaft and the second output shaft.

10. An actuator system comprising:
an electric actuating drive,
a first output shaft and a second output shaft,
at least one actuating element coupled to the first output shaft and/or to the second output shaft and coupled to a transmission element and which in conjunction with the transmission element converts a rotary motion of the first output shaft or of the second output shaft into a linear motion of the transmission element, and
a differential which is coupled on the input side to the electric actuating drive and which comprises the first output shaft and the second output shaft and which transmits and distributes a torque on the input side to the first output shaft and the second output shaft,
wherein the first output shaft and/or the second output shaft comprises a spindle, respectively.

11. The actuator system according to claim 10, wherein the first output shaft and the second output shaft are arranged on a common axis of rotation and facing away from one another on the output side.

12. The actuator system according to claim 10, wherein the first output shaft and the second output shaft are twisted with respect to one another in a first drive direction of the electric actuating drive and have a fixed position with respect to one another in a second drive direction of the electric actuating drive.

13. The actuator system according to claim 10, wherein the first output shaft is a hollow shaft, and the second output shaft is arranged so that it can rotate in the hollow shaft.

14. The actuator system according to claim 10, wherein the first output shaft has a first bevel gear and the second output shaft has a second bevel gear, and wherein the differential comprises a differential casing which takes up the torque on the input side and on which at least one planetary bevel gear which can rotate is arranged, by way of which the first bevel gear and the second bevel gear are coupled to one another.

15. The actuator system according to claim 14, wherein two planetary bevel gears are arranged opposite one another on a common axis of rotation.

16. The actuator system according to claim 10, wherein the differential is implemented as a spur-gear differential gear.

17. The actuator system according to claim 16, wherein the differential comprises a differential casing which takes up the input-side torque and on which at least one spur gear planetary gear set is arranged to be capable of rotation, which couples the first output shaft and the second output shaft with one another.

18. The actuator system according to claim 17, wherein the differential comprises at least three spur gear planetary gear sets which are arranged evenly around the first output shaft and the second output shaft.

19. An actuator system comprising:
an electric actuating drive,
a first output shaft and a second output shaft,
at least one actuating element which is coupled to the first output shaft and/or to the second output shaft and which is designed for coupling to a transmission element and which in conjunction with the transmission element converts a rotary motion of the first output shaft or of the second output shaft into a linear motion of the transmission element, and
a differential which is coupled on the input side to the electric actuating drive and which comprises the first output shaft and the second output shaft and which is designed to transmit and distribute a torque on the input side to the first output shaft and the second output shaft,
wherein the first output shaft and/or the second output shaft comprises a spindle, respectively, wherein the first output shaft has a first bevel gear and the second output shaft has a second bevel gear, and wherein the differential comprises a differential casing which takes up the torque on the input side and on which at least one planetary bevel gear which can rotate is arranged, by way of which the first bevel gear and the second bevel gear are coupled to one another.

20. The actuator system according to claim 19, wherein two planetary bevel gears are arranged opposite one another on a common axis of rotation.
